(19) United States
(12) Patent Application Publication
(10) Pub. No.: US 2007/0044924 A1
(43) Pub. Date: Mar. 1, 2007

(54) Sheet processing apparatus and image forming system

(75) Inventors: Kohji Yoshie, Sagamihara-shi (JP); Saburo Shimizu, Tokyo (JP); Riichi Hama, Tokyo (JP); Masahiro Kaneko, Tokyo (JP); Kiyoshi Hata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/498,068

(22) Filed: Aug. 3, 2006

(30) Foreign Application Priority Data
Aug. 31, 2005 (JP) JP2005-251005

(51) Int. Cl. B65H 37/04; B32B 37/12; B32B 38/14; B32B 37/18

(52) U.S. Cl. 156/578; 156/559; 156/356; 156/387

(57) ABSTRACT

A sheet processing apparatus includes a stacker to stack plural sheets thereon, and an adhesive-applying device that applies adheasive to a portion of a side of the plural sheets stacked on the stacker to bind the plural sheets in such a way that the adhesive-applied portion of the side is smaller than the adhesive-non-applied portion of the side.

This application is based on Japanese Patent Applications No. 2005-251005 filed on Aug. 31, 2005 in Japanese Patent Office, the entire content of which is hereby incorporated by reference.

### FIELD OF THE INVENTION

The present invention relates to a sheet processing apparatus that processes sheets for a document or the like and an image forming system having the sheet processing apparatus.

### BACKGROUND OF THE INVENTION

Sheets formed with an image, such as characters, patterns, and photographs are often subjected to biding-processing so that the sheets can be suitably handled for filing or the like. Accordingly, an image forming device, such as a copier and printer, is often installed with a post-processing device for post-processing, staple processing for example, as auxiliary equipment.

Conventionally, as a binding-processing device for binding-processing of plural sheets, devices that perform staple processing by the use of a binding-needle have been widely used.

Further, as a post-processing device suitably used in a combination with an image forming device, there is disclosed, in Patent Document 1 that is Japanese non-examined patent publication No. 2004-209870, a bookbinding apparatus that applies glue on one side of a sheet bundle to form a book.

Binding-processing of sheets by staple processing is a simple binding-processing that bundles sheets more simply than other binding-processing methods, such as bookbinding, and has the following major advantages.

(1) Binding-processing is simple.

Binding-processing of sheets by staple processing makes it possible to easily perform binding-processing with a simple instrument such as a stapler, and can be implemented on a small sized processing device, such as a post-processing device used in a combination with an image forming device.

(2) A bundle of sheets is held relatively firm, while it is also possible to separate the bundle of sheets.

(3) An increase in-volume of a book due to the thickness of glue, which is caused in the case of binding with glue, does not occur.

However, staple-processing has the flowing problems.

(1) There is a problem of disposal processing of documents and of recycle processing. Namely, in disposal processing, a stapled document needs more processes including an added process of separating a binding-needle when the document is brought into a disposal-processing with a typical example of incineration, because the stapled document is a mixture of flammable paper sheets and an nonflammable binding-needle.

(2) In recycle processing of sheets, more processes are needed because it is necessary to separate the binding-needle from the sheets.

(3) In separating a bundle into individual sheets, the ratio of a missing portion is high, which lowers the value as a document. In a critical case, a part of an image may be lost.

(4) Since a binding part of a bundle becomes higher than other parts, when plural bundles of stapled sheets are stacked, the binding parts become far higher than the other parts, which causes a problem with handling of the stacked body of the sheet bundles, such as filing and storing.

Another method for binding sheets is gluing the entire side of a sheet bundle, as disclosed in Patent Document 1 described above. Such binding is practical for a case where a bundle is not separated into individual sheets after binding. However, if a bundle may be separated after binding, a problem occurs that sheets get torn in the separation due to strong bonding.

Further, since a lot of glue is consumed, glue supplementation will be a problem in processing so frequent as in the case of stapling.

### SUMMARY OF THE INVENTION

In an aspect of the invention, there is provided a sheet processing apparatus, including:

a stacker to stack plural sheets thereon; and

an adhesive-applying device that applies adhesive to a portion of a side of the plural sheets stacked on the stacker to bind the plural sheets in such a way that the adhesive-applied portion of the side is smaller than the adhesive-non-applied portion of the side.

### BRIEF DESCRIPTION OF THE DRAWINGS

FIG. 1 is an entire view of an image forming system in an embodiment in accordance with the invention;

FIG. 2 is a front cross-sectional view of a post-processing device in the embodiment;

FIG. 3 is a cross-sectional view of a glue bath part in a binding unit;

FIG. 4 is a side view of an adhesive applying unit viewed from direction X shown in FIG. 2;

FIG. 5 is a diagram showing another example of an adhesive applying unit; and

FIGS. 6A and 6B are diagrams showing an example of an adhesive applying mode.

### PREFERRED EMBODIMENTS OF THE INVENTION

An embodiment in accordance with the present invention will be described below, referring to the drawings, however, the invention is not limited thereto.

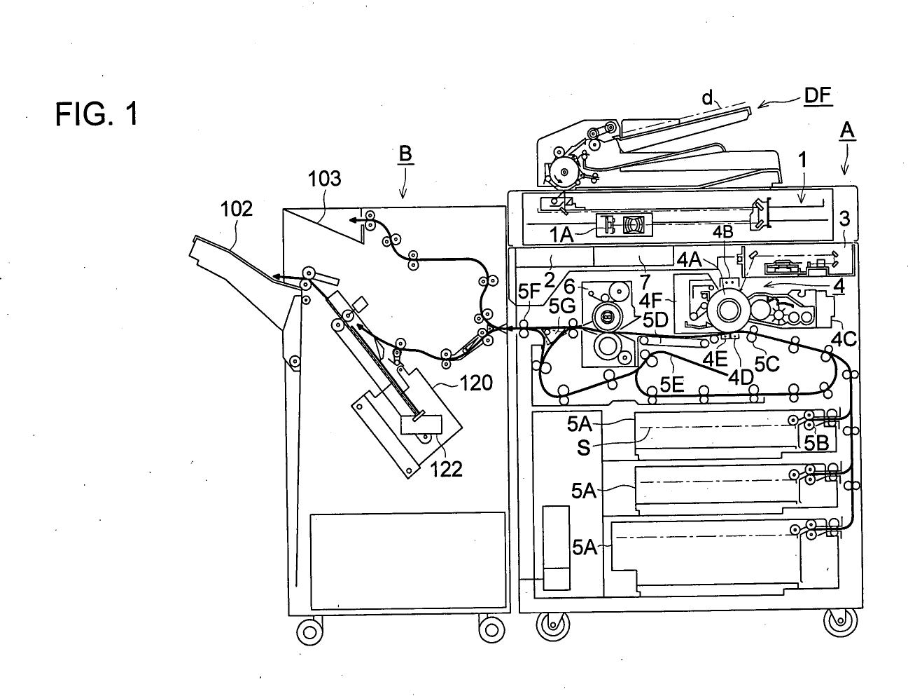

FIG. 1 is a diagram showing an image forming system having an image forming device A, automatic original document sheet feeding device DF, and a post-processing device B as a sheet processing device.

The image forming device A, shown, includes an image reading section 1, image processing section 2, image writing section 3, image forming section 4, sheet conveying section having a sheet feeding cassette 5A, first sheet feeding section 5B, second sheet feeding section 5C, first conveying section 5D, second conveying section (automatic both sides conveying section) 5E, and sheet ejecting section 5F, and further includes a fixing device 6. The image forming section 4 has a photoreceptor drum 4A, charging unit 4B, developing unit 4C, transferring unit 4D, separating unit 4E, cleaning unit 4F, and the like.

The automatic original document sheet feeding device DF is mounted on the upper part of the image reading section 1. The post-processing device B is connected to the sheet ejecting section 5F side on the left side surface of the image forming device A, as shown.

An original document sheet ‘d’ loaded on an original document sheet table of the automatic original document sheet feeding device DF is conveyed in the arrow direction, and an image is read by an optical system of the image reading section 1 from one side or both sides of the original document sheet ‘d’, and read by a CCD image sensor 1A.

An analog signal photo-electrically converted by the CCD image sensor 1A is subjected by the image processing section 2 to analog processing, A/D conversion, shading correction, image compression, and the like, and then the signal is transmitted to the image writing section 3.

In the image writing section 3, an output light from a semiconductor laser is irradiated onto the photoreceptor drum 4A of the image forming section 4 to form a latent image. In the image forming section 4, processings including electrical charging, exposing, developing, separation, cleaning, and the like are performed. The image is transferred by the transfer unit 4D to a sheet ‘S’ that has been fed from the sheet feeding cassette 5A and through the first sheet feeding section 5B. The image carried by the sheet ‘S’ is fixed by the fixing device 6 and the sheet ‘S’ is conveyed from the sheet ejecting section 5F to the post-processing device B. Otherwise, the sheet ‘S’ on which one side an image has been formed and which has been conveyed by a convey path switching plate 5G to the second conveying section 5E is again subjected to image forming in the image forming section 4, thus both side being subjected to image forming, and then the sheet ‘S’ is ejected from the sheet ejecting section 5F.

(Post-processing device)

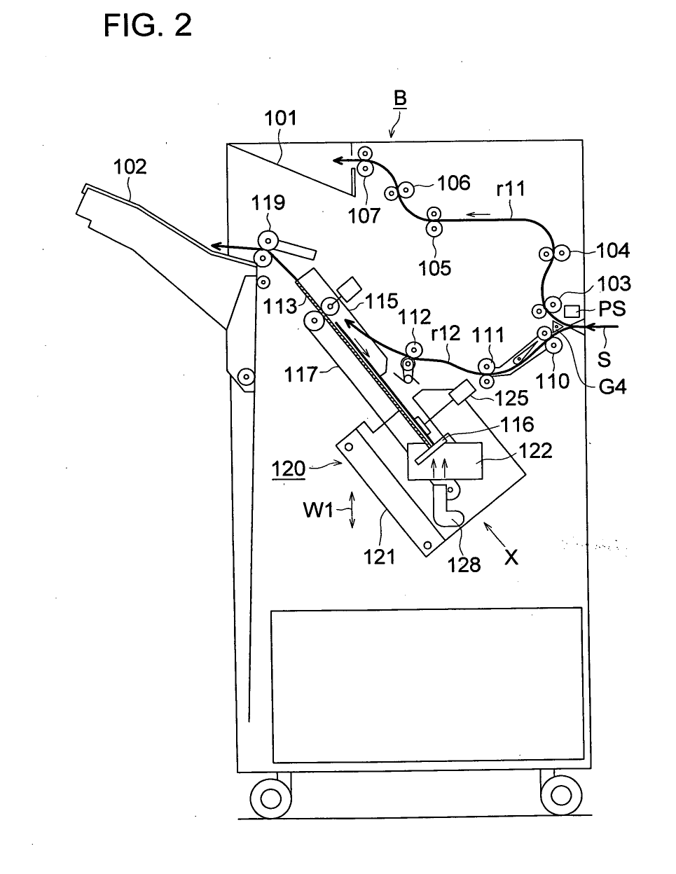

FIG. 2 is a front cross-sectional view of the post-processing device B as a sheet processing device.

The sheet ‘S’ ejected from the image forming device A to the entrance of the post-processing device B is conveyed to a conveying path r11 upper than a convey path switching unit G4 or to a conveying path r12 lower than it. A sheet ‘S’ branched to the conveying path 11r is sandwiched and conveyed by conveying rollers 103 to 106, ejected by ejecting rollers 107, and loaded on a sub-ejecting tray 101 as an ejecting section disposed at the upper part of the post-processing device B. Recording sheets formed with an image as a trial, a recording sheet to be ejected after jam processing, and the like are ejected onto the sub ejecting tray 101.

Sheets ‘S’ branched to the conveying path rl2 are sandwiched and conveyed by conveying rollers 110 and 111, released by registration rollers 112, and sequentially stacked onto an intermediate stacker 113. A stopper 116 receives the sheets ‘S’. The sheets ‘S’ stacked on the intermediate stacker 113 are aligned by the stopper in the conveying direction and aligned by an aligning unit 115 constructed with a plate for regulating the position in the conveying width direction so that the sheets ‘S’ are position-fixed, and then the sheets ‘S’ are subjected to binding processing by a binding unit (binder) 120 to be formed into a sheet bundle.

Sheets ‘S’ which having not been subjected to post-processing are conveyed through sheet ejecting rollers 119 to be ejected to the sheet ejecting tray 102, and sheets ‘S’ having been subjected to aligning and sheets ‘S’ having been subjected to binding are conveyed by a conveying belt 117 and conveyed through the sheet ejecting rollers 119 to be ejected to the sheet ejecting tray 102.

At a sheet entrance opening of the post-processing device B, a photo-sensor PS is disposed as an entrance sensor to detect the front end back ends of a sheet ‘S’ fed out from the image forming device A into the post-processing device B.

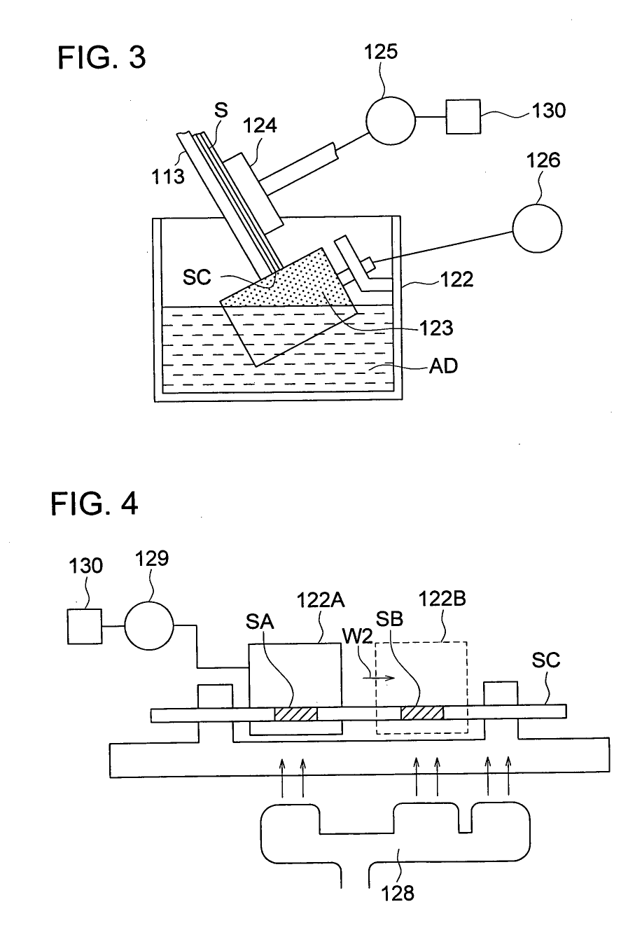

The binding unit 120 will be described, referring to FIGS. 3 to 5.

FIG. 3 is an enlarged cross-sectional view of a glue bath 122 in the binding unit 120. FIG. 4 is a side view of an adhesive applying section viewed from arrow X in FIG. 2.

The binding unit 120 performs binding by the use of an adhesive. For the binding unit 120, a unit frame 121 (refer to FIG. 2) is fitted with the glue bath 122 for storing a liquid AD, such as a hotmelt adhesive, an adhesive-applying roller 123, a pressing member 124 for pressing sheets ‘S’, and a drying unit 128 including a blast fan and duct.

For the adhesive to be used for binding, various kinds of adhesives can be used which are conventionally used in bookbinding, such as a hotmelt adhesive. Particularly, recycle suitable adhesives, such as olefin system hotmelt adhesives and synthetic rubber adhesives, are preferable, and a glue bath 122 is replaceably mounted to allow selection of an adhesive to be used, from high bonding adhesives, instant-drying adhesive, and the like.

The adhesive to bind a side of the bundle of sheets is stored in the glue bath 122, and more or less of the bottom half of the adhesive-applying roller 123 is put in the adhesive solution AD.

The adhesive-applying roller 123 contacts with a bottom side SC of the sheets ‘S’ stacked on the intermediate stacker 113.

The adhesive-applying roller 123 is supported by a support arm provided at the glue bath 122 and is rotationally driven by a motor 126. The glue bath 122 is movable between the position 122A shown by solid lines and the position 122B shown by dashed lines, and a control unit 130 controls the motion of the adhesive bath 122. The adhesive-applying roller 123 rotates, driven by the motor 126, while the glue bath 122 is moving,. and applies the adhesive to the bottom side SC of the bundle of sheets.

The pressing member 124 moves between a pressing position (the lower position) and a retracted position (upper position), driven by the motor 125. Herein, the control unit 130 controls the motor 125 and stops the pressing member 124 at a pressing position corresponding to the thickness of a bundle of sheets on the intermediate stacker to pressingly hold the bundle of sheets.

The binding processing by the binding unit 120 will be described below.

The binding unit 120 can rise and fall, as shown by arrow W1 in FIG. 2, and is retracted at the lower position when binding processing is not performed.

When sheets ‘S’ in a set number are stacked on the intermediate stacker 113 and alignment by the aligning member 115 terminates, the pressing member 124 falls, driven by the motor 125, and presses the bundle of sheets ‘S’.

Then, the binding unit 120 is raised by a motor (not shown) so that the adhesive-applying roller 123 comes in contact with the bottom side SC of the bundle of sheets, and the glue bath 122 moves in the direction of arrow W2 in FIG. 4, while the adhesive-applying roller 123 is rotating, driven by the motor 126, to apply the adhesive to the bottom side SC.

The binding unit 120 falls when the adhesive has been applied to an adhesive-application area of the bottom side SC, shown by SA, the adhesive-applying roller 123 separates from the bottom side SC. In such a manner, the adhesive is applied to the specified adhesive-application area SA of the bottom side SC.

Thereafter, when the binding unit 120 has moved in the arrow W2 direction to the position shown by the dashed lines in FIG. 4, the binding unit rises again so that the adhesive-applying roller 123 comes in contact with the bottom side SC. In a state where the adhesive-applying roller 123 is in touch with the bottom side SC and rotating, the binding unit 120 moves further in direction W2. Thereafter, the binding unit 120 falls and the adhesive-applying roller 123 separates from the bottom side SC. Thus, the adhesive is applied to a specified adhesive-application area SB of the bottom side SC.

In a state where the adhesive-applying roller 123 is separated from the bottom side SC, a drying unit 128 blows dry air to dry and solidify the adhesive, and thereby binding processing of the bundle of sheets S is completed.

Although in the shown example, a single adhesive-applying roller 123 is used to apply the adhesive at plural positions, it is also possible to us adhesive applying rollers in a quantity corresponding to the number of adhesive-application positions, and apply the adhesive to areas at the plural positions without moving the adhesive application roller.

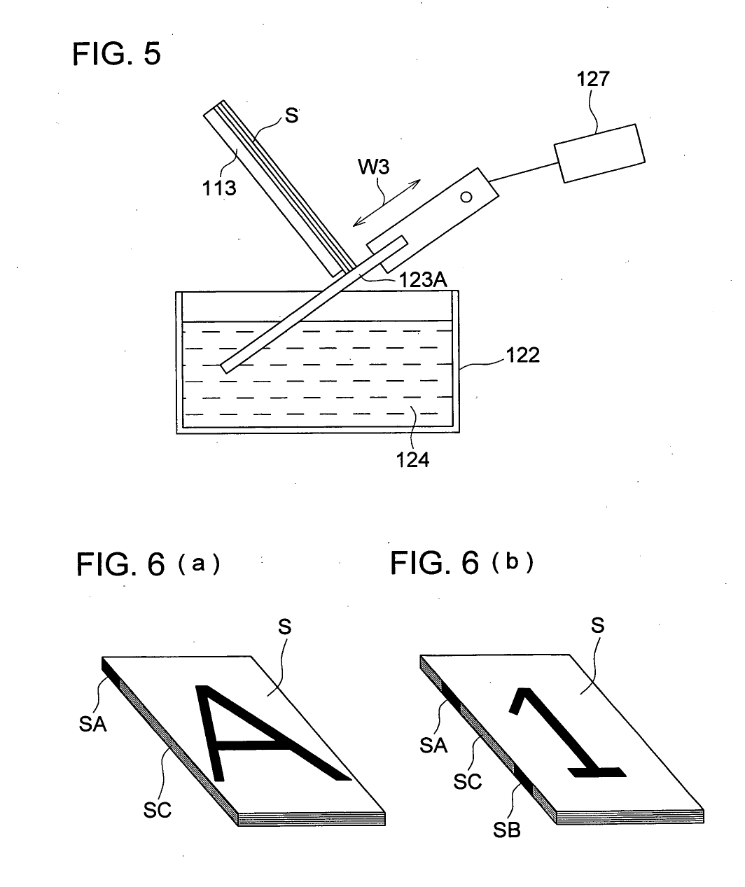

FIG. 5 shows another example of an adhesive-applying unit.

In the example in FIG. 5, an adhesive-applying blade 123A is used as an adhesive-applying unit for applying an adhesive to a bundle of sheets ‘S’.

The edge part of the adhesive-applying blade 123A is put in the adhesive solution AD in the glue bath 122, and moves, as shown by arrow W3, driven by a solenoid 127. The adhesive-applying blade 123A has the same width as the adhesive-application areas SA and SB in FIG. 4, and moves up and down, as shown by arrow W3, in a state of contact with the bottom side SC of the bundle of sheets ‘S’, thereby the adhesive is applied to the adhesive-application areas. In a case of applying adhesive at plural positions, a single adhesive-applying blade may be moved, or plural adhesive-applying blades may be used.

FIGS. 6A and 6B show examples of adhesive-applying modes.

An adhesive-application area is a part of a side SC of a bundle of Sheets ‘S’. If adhesive is applied to the entire side SC or a most portion of the side SC to perform binding processing, the separability of sheets, which is a feature of a simplified processing, such as staple processing, is degraded. That is, in a case of gluing the entire or most portion of a side SC to perform bonding processing, the resistance against separation of the sheets becomes high, which tends to cause a problem that sheets get torn.

Accordingly, it is important to perform binding processing, applying adhesive to a small portion without applying adhesive to a portion greater than a half of a side SC, in other words, to perform binding processing in such a manner that the adhesive-applied portion of the side is smaller than the adhesive-non-applied portion of the side.

FIG. 6A shows an example of setting an adhesive-application area SA at the upper part of a side SC, and FIG. 6B shows an example of setting adhesive-application areas SA and SB at the upper and lower parts of a side SC.

Binding processing, as shown in FIGS. 6A and 6B, achieves a binding processing that is strong and is secured for separability of sheets.

Further, since the above described binding processing uses adhesive, a bundle of sheets subjected to the binding processing can be handled as a flammable material when it is disposed of, which simplifies the disposal process. Further, also for recycling sheets, a separation process to separate a staple needle from the sheets, which is required in a case of staple binding, is unnecessary and thus recycling is made easier.

Effects obtained in the present embodiment include the followings:

A bundle of sheets can be produced through binding processing suitable for disposal and recycling, and allows easy separation of one or plural sheets from the bundle.

A bundle of sheets of which plural sheets are favorably aligned at the edges can be produced through binding processing capable of generating few irregularities and strong bonding.

A binding position/positions and the number of a binding area/areas can be changed, corresponding to the use for a bundle of sheets subjected to binding processing, the size of sheets, the number of sheets for binding, and the like.

Suitable binding processing is realized, corresponding to the nature of sheets for binding, the use for a bundle of sheets subjected to binding processing, and the like.

Binding processing by the use of a simple adhesive-applying unit to bind an area/areas at an accurately regulated position/positions is realized.

What is claimed is:

1. A sheet processing apparatus, comprising:
a stacker to stack plural sheets thereon; and
an adhesive-applying device that applies adhesive to a portion of a side of the plural sheets stacked on the stacker to bind the plural sheets in such a way that the adhesive-applied portion of the side is smaller than the adhesive-non-applied portion of the side.

2. The sheet processing apparatus of claim 1, further comprising a pressing device that presses the stacked sheets on the stacker, wherein the adhesive-applying device applies adhesive to the sheets pressed by the pressing device.

3. The sheet processing apparatus of claim 1, wherein the adhesive-applying device applies adhesive to a single area of the side.

4. The sheet processing apparatus of claim 1, wherein the adhesive-applying device applies adhesive to plural areas of the side.

5. The sheet processing apparatus of claim 1, further comprising a control device that controls a position or positions and/or a number of area or areas for adhesive-application.

6. The sheet processing apparatus of claim 1, further comprising a drying device for drying an adhesive-application area.

7. The sheet processing apparatus of claim 1, wherein at least the adhesive applying device is in a form of a unit.

8. The sheet processing apparatus of claim 1, wherein the adhesive-applying device replaceably comprises a glue bath for storing adhesive.

9. The sheet processing apparatus of claim 1, comprising a plurality of adhesive-applying devices that apply adhesive to plural adhesive-application areas.

10. The sheet processing apparatus of claim 1, wherein the adhesive-applying device comprises an adhesive-applying roller.

11. The sheet processing apparatus of claim 1, wherein the adhesive-applying device comprises an adhesive-applying blade.

12. An image forming system, comprising:
an image forming apparatus that forms an image on a sheet; and
the sheet processing apparatus of claim 1 that binds a plurality of sheets on which an image has been formed by the image forming apparatus.
